(19) United States
(12) Patent Application Publication
(10) Pub. No.: US 2017/0262345 A1
(43) Pub. Date: Sep. 14, 2017

(54) Backup, Archive and Disaster Recovery Solution with Distributed Storage over Multiple Clouds

(71) Applicants: Jenlong Wang, Los Altos, CA (US); Yu-Zen Chang Wang, Los Altos, CA (US)

(72) Inventors: Jenlong Wang, Los Altos, CA (US); Yu-Zen Chang Wang, Los Altos, CA (US)

(21) Appl. No.: 15/068,548

(22) Filed: Mar. 12, 2016

(51) Int. Cl. G06F 11/14; H04L 29/08

(52) U.S. Cl. CPC G06F 11/1464; G06F 11/1469; H04L 67/1097; G06F 2201/805; G06F 2201/84

(57) ABSTRACT

This invention is a software application utilizing distributed storage systems to provide backup, archive and disaster recovery (BCADR) functionality across multiple clouds. The multi-cloud aware BCADR application and distributed storage systems are utilized together to prevent data lost and to provide high availability in disastrous incidents. Data deduplication reduces the storage required to store many backups. Reference counting is utilized to assist in garbage collection of staled data chunks after removal of staled backups.

### BACKGROUND

Field of the Invention

This invention relates to the field of software solution for backup and disaster recovery. More specifically, this invention is a software application utilizing distributed storage systems to provide backup, archive and disaster recovery (BCADR) functionality across private cloud and multiple public clouds providers.

Description of the Related Art

A reliable BCADR solution is essential for enterprises and consumers to keep their critical data available even after a disastrous incident causing data lost at the primary data site. There are many BCADR solutions in the market which incorporates various technologies to protect, backup and recover physical server and virtual server files, applications, system images as well as endpoint devices. These BCADR products provide features such as traditional backup to tape, backup to conventional disk or virtual tape library (VTL), data reduction, snapshot, replication, and continuous data protection (CDP). These solutions may be, provided as software only, or as an integrated appliance that contains all or substantial components of the backup application, such as backup management server or a media server.

Most the BCADR solutions perform backup, archive and recovery against either locally connected SAN/NAS devices or remote storage at cloud providers. Typically, data replication to remote cloud/site requires a different product. BCADR to public clouds is yet another product.

### SUMMARY

Besides the fundamental backup, archive and recovery features provided by the existing solutions, a reliable BCARD deployment must consider additional concerns: (1) data accessibility and availability in the event of any or multiple backup system failure; (2) scalability to accommodate fast data growth and increased BCADR demands; (3) replication to remote corporate site or public clouds to handle site disaster; (4) Data deduplication to reduce the storage required by ever increasing backup version; (5) agnostic interface among public cloud providers if multi-cloud solutions are provided. To alleviate the BCADR risks and concerns, enterprises usually resort to deploying and integrating multiple solutions to reduce risk. Increased complexity and responsibility gaps among different product vendors often make the deployment challenging to the users. This invention utilizes replicated and distributed storage systems (DSS) as the fundamental building block to provide high availability data storage. The DSS component utilizes the technologies described in Google Bigtable, Amazon Dynamo and Apache Cassandra. The DSS can be deployed over multiple clouds including private enterprise clouds (primary and replicated) and public clouds. DSS provides fault tolerant capability to handle failure of storage nodes, it can easily scale for capacity and processing demand as the data size grows. A BCADR application combines with the DSS to deliver the data replication functionality to remote site and public clouds. User can elect to have backup versions stored public clouds besides the enterprise private cloud infrastructures. Data de-duplication is performed by both BCADR application and DSS to reduce the storage consumptions at all cloud storages. Regardless of the public cloud provider chosen, users observe the same interface through the BCADR application.

### BRIEF DESCRIPTION OF THE DRAWINGS

FIG. 1: High-level multi-cloud BCADR architecture of the present invention

FIG. 2: Multi-cloud BCADR architecture for Virtual Machines with this invention

FIG. 3: A Snapshot Group with many File Stores or many Virtual Machines

FIG. 4: A Component in a Snapshot Group

FIG. 5: Work-flow for backup, archive and disaster-recovery operations managed by the SnapCache appliance.

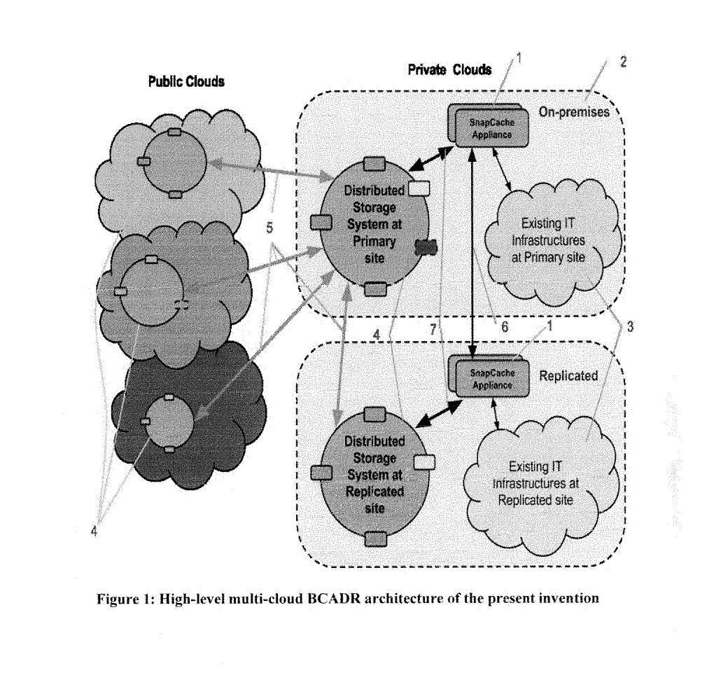

### REFERENCE NUMERALS IN FIG. 1

(1) SnapCache appliances.
(2) On-premises cloud infrastructure
(3) Existing IT infrastructures at the primary and replicated sites
(4) Distributed storage systems at the primary, replicated and public clouds
(5) IOs among the primary storage site and replicated/public clouds
(6) Synchronization between SnapCache appliances in the primary and replicated sites
(7) IOs between SnapCache appliance and the primary distributed storage system.

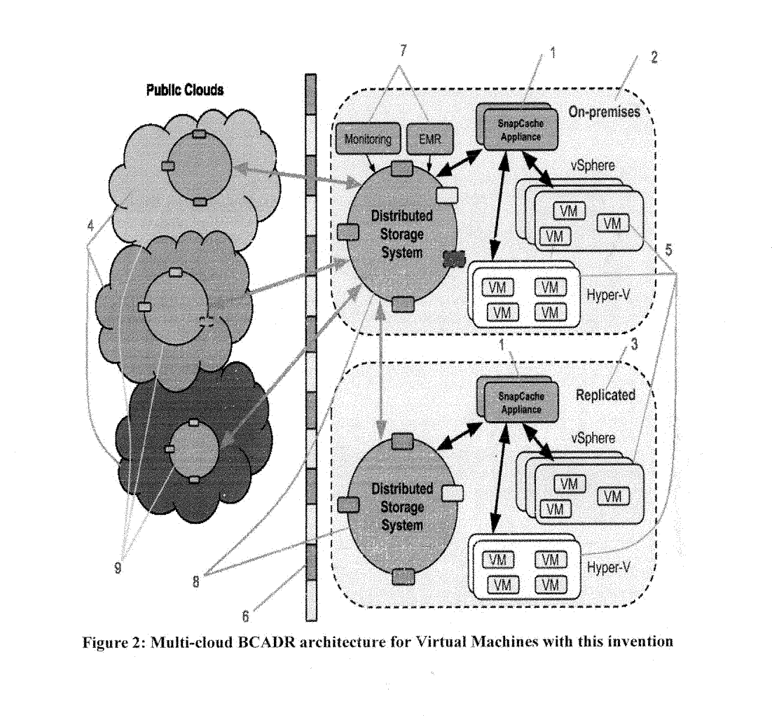

REFERENCE NUMERALS in FIG. 2

| | |
|---|---|
| (1) SnapCache appliance | (2) On-premises cloud infrastructure |
| (3) Cloud infrastructure at | (4) Public clouds |
| replicated site | |

(5) Existing Virtual Machine infrastructures (Vmware vSphere or
Microsoft Hyper-V)

| | |
|---|---|
| (6) Firewall | (7) Statistics and Monitoring apps |
| (8) Distributed storage in | (9) Distributed storage in public clouds |
| private clouds | |

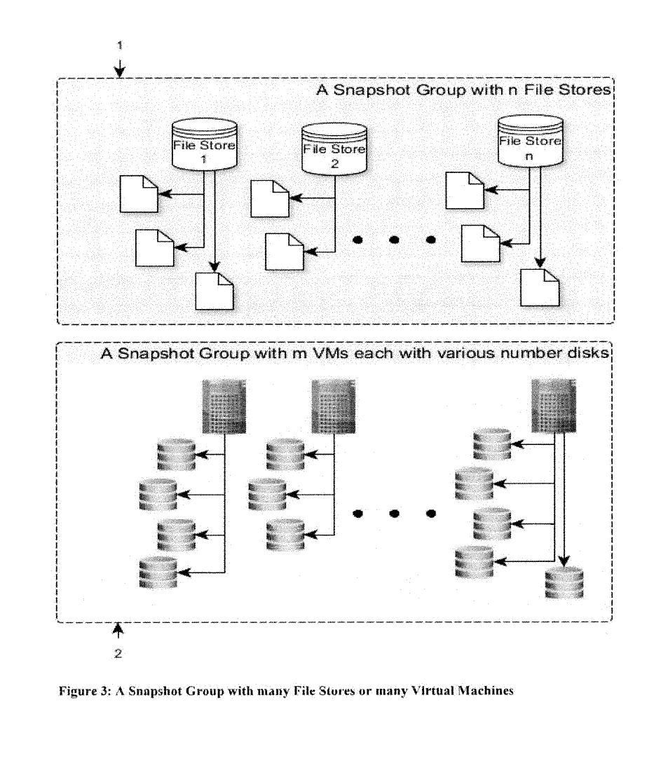

### REFERENCE NUMERALS IN FIG. 3

(1) A Snapshot Group (SG) with n File Stores (FSs)
(2) A Snapshot Group with m Virtual Machines (VMs)

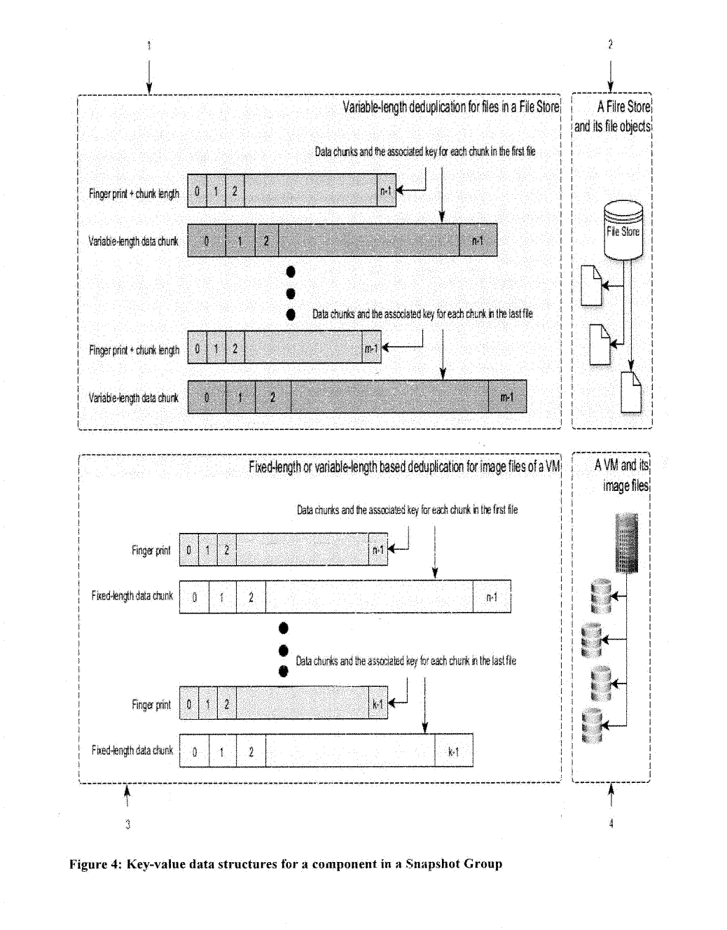

### REFERENCE NUMERALS IN FIG. 4

(1) Variable-length deduplication for file objects of a File Store component in an SG.
(2) An FS component in an SG. The corresponding data structures are represented in (1).
(3) Fixed-length or variable-length deduplication for image files of a VM component in an SG.
(4) A VM component in an SG. The corresponding data structures are represented in (3).

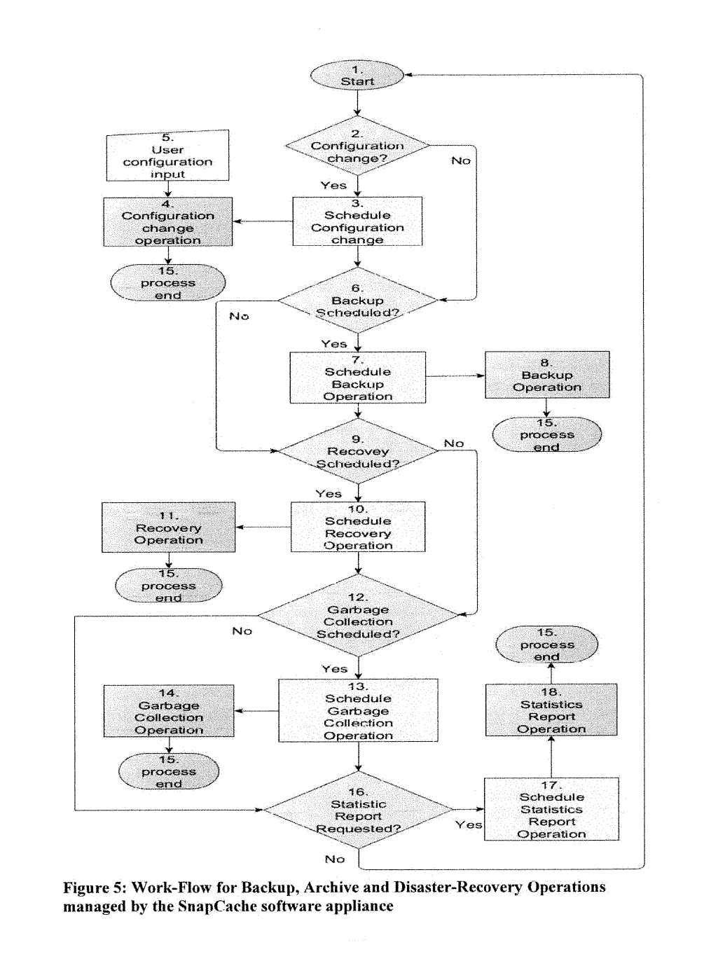

### REFERENCE NUMERALS IN FIG. 5

(1) To (18) the referenced numbers are denoted in the associated steps in the figure.

### DETAILED DESCRIPTION

FIG. 1 shows the components for the BCADR solution with distributed storage over multiple clouds including on-premises, replicated and public clouds. SnapCache (1) is a software appliance, a software application packaged in a VM or a container. SnapCache drives the BCADR work flow to protect IT infrastructures at the on-premises primate site (2). The private clouds include the existing IT infrastructures at the on-premises and replicated sites (3). Business continuity with replication is achieved by replicating data in DSS from the on-premises site to the replicated site. The BCADR data (including meta-data) are stored in the distributed storage systems (DSS) (4) with user controlled redundancy via configuration parameters. DSS utilizes concepts from Google Bigtable, Amazon Dynamo, and Apache Cassandra distributed storage technologies. Users can configure each protection group (a collections of VMs or file stores) with the intended cloud providers. The replication IOs and controls exist among the primary and replicated/public clouds (6). The SnapCache appliance backs up and recovers the protected resources with the storage from DSS (7). Access to a data chunk for any backup version will read from local cache in private cloud first before. If the DSS in the private cloud does not have the specific data chunk (i.e., a read cache-miss), data will be fetched from public clouds.

FIG. 2 shows the invention applied to virtual machines BCADR. The SnapCache Appliance (1) drives the virtual machine (VM) BCADR work flow. The on-premises private cloud (2) is the primary data-center/office site for an enterprise while the replicated private cloud (3) is typically located at a remote data-center/office site geographically apart from the primary on-premises site. Each site, (2) and (3), can contain a set of replicated Vmware vSphere or Microsoft Hyper-V virtual machines (5). The DSS at replicated site is used by the SnapCache to recover VMs failure at the primary (on-premises) site. States of the grouped VMs can be saved at and restored to any specific (identical) time. The relevant virtual machines are grouped as a unit of protection as shown in (5). A user can group dependent VMs which collectively provide a critical service. For example, a 3-tier CRM web architecture where presentation, logic, and database components can run in different virtual machines. Public clouds (4), for example, Amazon Web Services, Google Cloud platform and Azure, are utilized to store and archive all backups for long-term storage. Firewalls (6) are expected between enterprise private clouds and public clouds. Big data applications (7), such as Elastic-Map-Reduce and Monitoring, gather and use the information in the distributed storage systems (8) to provide addition insight for storage and cluster systems. The backups are kept in distributed storage in the public clouds (9) as well.

FIG. 3 describes the Snapshot Group (SG) definition. An SG is a collection of several components where the states of all components can be snapshotted at a specific time and states of changes are saved to all configured DSSs. Each component is either a VM or a File Store (FS). An FS represents a storage pool, device, volume or file system used to store file objects. The states of the components can also be recovered to a previously saved backup. An SG can contain many File Stores, i.e., FIG. 3-(1), where each FS component consists of multiple files. Alternatively, an SG can be a set of VMs where each VM component can have multiple disks, i.e., FIG. 3-(2).

FIG. 4 describes the key-value data structures of an SG component. An FS component and its files are shown in FIG. 4-(2). In FIG. 4-(1), each file is separated into contiguous data chunks and each data chunk has the associated finger-print computed using combination of cryptographic hash functions such as SHA1, MD5, etc. The keys are ordered according to the offset of data chunks. The first key is associated to the first data chunk, etc., and the last key for the last data chunk. A VM component and its image files (disks owned by the VM) are shown in FIG. 4-(4). Each disk image file is divided to contiguous fixed-length or variable-length data chunks as shown in FIG. 4-(3). Similarly, cache data chunk has its associated key computed with cryptographic hash functions.

Both variable-length and fixed-length chunk size are supported. The variable-length chunk boundary is determined by an implementation of Rabin fingerprint algorithm.

Fixed-length chunk size can be used to reduce the computational cost related to variable-length chunking at the expense of deduplication rate. As more backups are performed on an SG component (VM or FS), it is highly likely that there are high duplications in data chunks between successive backups. The SnapCache stores only one copy of each unique data chunk and its associated meta-data. Each unique data chunk is replicated to provide higher data availability. The replication-factor is configurable by the user. The uniqueness of the data chunk is determined via a key which includes finger-print and meta-data of the associated data chunk.

FIG. 5 describes the high-level control flow for backup, archive and disaster recovery operations managed by the SnapCache appliance. Details as follows:

Step 1: Start: the SnapCache software appliance is started.
A. Initialization including reading the existing configuration.
B. Recover the states from the last known good States using the logs.
   Step 2: Is configuration change requested? This step is triggered by a user request.
   Step 3: Schedule configuration change. A process or thread is forked to handle the configuration operation as described in step 4. At the process or thread completion, it exits without affecting the control flow.
   Step 4: Configuration change operation. Create or modify the configuration for a Snapshot Group (SG). An SG consists of relevant VMs in hypervisors or relevant file system directories in several systems. The configuration parameters are as follows.
A. General backup and restore policy:
   1) Define or modify an SG where a component of the SG can be either be a VM or an FS for file system directory/folder. An SG with n components can be represented as a set of n-tuple {(id-1, SG-component-info-1), . . . , (id-n, SG-component-info-n)} where id-1, . . . id-n uniquely identifies the SG-components.
   2) Backup frequency: manual trigger, hourly, daily, weekly or at a defined time/schedule. The default value is hourly for file systems and daily for VM.
   3) Notification mechanism setup for administrator email
   4) Define if fixed or variable-length chunking should be used. The default is fixed-length for a VM component and variable-length for an FS component.
B. Configuration for the local SG cache for the on-premises private cloud.
   1) Storage limit for this SG in the local cloud storage. E.g., 16 TB max. A least-recently-used (LRU) data chunk will be removed if the storage limitation is achieved to accommodate new backup or data recovery.
   2) Retention policy: (default is 90 days) the storage duration of the SG
   3) Garbage collection frequency for storage: hourly, daily, weekly, manual trigger? The default is triggered after a backup or restore operation is completed.
   4) Statistics reporting. The default is daily.
C. Remote replicated cloud configuration.
   1) The remote replicated cloud related location and resource information.
   2) Save and mirror the configuration in on-premises setup.
D. Public cloud providers if any.
   1) Cloud provider access control: the access control for AWS, Google cloud platform or Azure.
   2) Retention policy: By definition, all VM backups in the public clouds are stored indefinitely unless an expiration date is specified or if removal operation of the given backup version is requested.
      Step 5: User configuration input. Configuration input is through modified configuration files.
      Step 6: Determine if a backup operation is pending for any SG.
      Step 7: Similar to step 3. A process or thread is forked to handle the backup operation as described in step 8. When process completes, it exits.
      Step 8: Backup operations proceed as follows.
A. Load the configuration and current known state for the SG.
B. Create a snapshot state (say at time_1) for SG, defined as SG-1
C. Find the latest known good snapshot of SG (say at time_0), defined as SG-0.
D. For each SG component id (a VM or an FS) of this SG.
E. For each file (a file in an FS or image file in a VM) of the component id (from D)
   1) Calculate the change deltas between snapshots SG-1 and SG-0.
      Output: a list of data chunks where each chunk is a contiguous steam of data of either fixed or variable-length block. The list is ordered by the data chunk offset in the file.
F. For each chunk in the list (for the SG component id in E).
   1) Calculate finger-print for the chunk using combination of cryptographic hash functions (e.g., MD5, SHA1, SHA256, etc.).
   2) Calculate key where key=finger-print+optional meta-data. The optional meta-data is content and application-specific. For variable-length chunk, the chunk-length can be part of the meta-data.
   3) Use the combination of hash functions and key to check if the chunk existed?
      If not existed:
         Compress the data chunk
         Use key and hash function, hash(key)->location, to determine the chunk store location. Store the compressed data in the following order
            Store in the on-premises private cloud
            Save the chunk data information into a reliable queue service for saving the chunk to replicated site and public clouds.
      If the data chunk existed, no need to save the data.
   4) Back to F. Process the next data chunk
G. Stores keys+optional meta-data for all chunks including the duplicated chunks (in sorted order according to data chunk offset) related to this SG for time_1 in the following order. The key+metadata information allows reconstruction of time_1 snapshot of the file (E) at a later time.
   1) Store in the on-premises private cloud
   2) Save the keys for all chunks to a reliable queue and schedule write to
      Store all key info for this component id in the replicated private cloud
      Store all key info for this component id in each public cloud provider
H. Back to E. Process the next file.
I. Calculate the key reference count: for all files in the component id (a VM or an FS), perform a map-reduce operation on all keys and provide a count for each key occurrence.
   1) Store the key reference counts of this component id at SG-1.
J. Back to D. Process the next component id. Note: the per-component-id processing are performed in parallel.
K. For each component id in the SG
   1) Update (add with reference count for each key in I-1) the accumulated key reference counts for all component id for this SG. Each SG component has an associated key reference count table. When the reference count of a key is 0, it indicates that the associated data chunk is no longer needed and can be garbage collected.
   2) Store the accumulated reference counts for all keys of the SG component
      Step 9: Determine if a recovery operation is pending for any SG.
      Step 10: Similar to step 3. A process or thread is forked to handle the recovery operation as described in step 11. When process completes, it exits.
      Step 11: A recovery operation is either recover to existing resources or new resources.
      11-(1) to existing resources. I.e., the recovery data are written to existing SG resources. A snapshot is taken for the SG and the recovered data chunks are overlaid on the current existing data chunks. Details as follow.
A. (According to user input) User at time_2 indicates that an SU needs to be recovered to snapshot states at time_1, namely SG-1.
B. Load configuration and state at SG-1 for this SG.
C. Create snapshot of the current SG (said at time_2), namely SG-2
D. If the SG is running, freeze (or stop serving) VMs or FSs in this SG to prevent unnecessary data changes before the restore operation completes. Force
E. For each component id (a VM or an FS) of this SG
F. For each file (a file in an FS or image file in a VM) of the component id (from E)
   1) Calculate change deltas for this file between snapshots SG-1 and SG-2
      Output: a list of keys representing file deltas where the associate data chunks are different between SG-1 and SG-2. Each chunk is a contiguous steam of data of either fixed or variable-length block. Conceptually, the list is a k-tuple of {(key-1, offset-1), (key-2, offset-2), . . . , (key-k, offset-k)}. Each key is finger-print+optional meta-data where meta-data can contain additional chunk length information.
      When SG-1 and SG-2 differ significantly and SG-1-id tuple is available in the private cloud, it might be advantageous to use files related to SG-1-id directly. This could save the time for computing finger prints at SG-2 and comparing file deltas between SG-1 and SG-2.
G. For each key in the list for the given file (from in F)
   1) Determine the method of recovery, i.e., using key to retrieve the mapped data chunk. Since the data chunk can reside both in the local on-premises or public clouds. The costs of access a chunk from a cached-copy from the local private cloud and remote public clouds are fairly different. The costs among public cloud vendors vary also. The solution picks a lower cost one to retrieve the data chunk.
      Read data using the key to retrieve the mapped data chunk from the distribute storage.
         Read from cached data in local on-premises cloud
         If miss, read from the replicated site (with the assumption that replicate site has lower latency and high bandwidth connection to the primary site comparing to the connection to public clouds).
         If miss again, read from the public clouds.
   2) Write chunk data at the given file offset and length where the offset and length information derived from the file and key.
   3) Loopback to step G) to get the next key in list for retrieving the next data chunk
H. Loopback to (F) for the next file in the component id (in F).
I. Loopback to (E) for the next component id in the SG (in E).
   11-(2) to new resources. I.e., the recovery data is written to new SG resources. This recovery option can be used to recovery a non-existing SG (e.g., migration of FSs or VMs) or when a user need to perform validation and test VM/FS backups. Details as follow.
A. (According to user input) an SG needs to be recovered to snapshot states at time_1, namely SG-1.
B. Load configuration and state at SG 1 for this SG.
C. For each component id (i.e., a VM or an FS) of this SG
D. For each file (a file in an FS or image file in a VM) of the component id (from C)
   1) Get a list of keys and meta-data (offset, length, etc.) associated with the contiguous data chunks for the file.
E. For each key in the list for the file (from in D)
   1) Determine the method of recovery, i.e., using key to retrieve the mapped data chunk, Since the data chunk can reside both in the local on-premises or public clouds. The costs of access a chunk from a cached-copy from the local private cloud and remote public clouds are fairly different. The costs among public cloud vendors vary also. The solution picks a lower cost one to retrieve the data chunk.
      Read data using the key to retrieve the mapped data chunk from the distribute storage.
         Read from cached data in local on-premises cloud
         If miss, read from the replicated site (with the assumption that replicate site has lower latency and high bandwidth connection to the primary site comparing to the connection to public clouds).
         If miss again, read from the public clouds
   2) Write data to the file at the given offset and length associated with the key and data chunk.
   3) Loopback to (E) to get the next key in list for retrieving the next data chunk
F. Loopback to (D) to for the next file in the component id (in D).
G. Loopback to (C): for the next component id (in C)
   Step 12: Determine if a garbage collection operation is pending for any SG. The garbage collection step removes the staled data chunks and the associated key-value mapping. The staled data chunks are the result of expired backup or backup version removal. A garbage collection can be triggered via SG policy, e.g., based on capacity, SG backup removal event, or user manual trigger. The garbage collection operation reduces the capacity demand and the associated cost for the accumulated backups.
   Step 13: Similar to step 3. A process or thread is forked to handle the garbage collection operation for this SG as described in step 14. When process completes, it exits.
   Step 14: Garbage collection operation to remove the un-used data chunk and key-value mapping. The operation is triggered by removal of an SG. Details as follows.
A. An SG at time_1, namely SG-1, is identified to be removed.
B. Determine the scope of removal. The retaining policy for an SG can be different for private cloud and public clouds. E.g., private cloud can have backup retaining policy of 90 days while 3 years for public clouds. Hence, the removal might be only applicable to the SG-1 backup in the private cloud only.
C. For each applicable removal SG-1 in different sites include primary site, replicated sites and public clouds.
D. Load configuration and state at SG-1 for the given site (from C).
E. For each component id (i.e., a VM or an FS) of this SG-1.
   1) Obtain the stored key reference count calculated and stored (described in the backup operation Step 8-I) for this component id.
   2) Subtract the accumulated reference count with the reference count in (1) for each key in (1).
   Remove the data chunk for any key has 0 reference count value.
      Step 15: This step simply terminates the process or thread forked from the main work flow process.
      Step 16: Determine if statistics report was requested. The statics report generation is triggered by per SG policy. The policy defines the frequency and time of the statistic report generation.
      Step 17: Similar to step 3. A process or thread is forked to handle the statistics report operation for this SG as described in step 18. When process completes, it exits.
      Step 18: Statics report generation. Statistics information are gathered and analyzed for resources in private clouds (primary and replicated sites) and public clouds. Statistics information includes the following:
1. User backup and recovery activities.
2. History information of the protected resources.
3. Per protection group activities.
4. Storage consumption per protection group and detailed per-component analysis.
5. Data chunk access latency, bandwidth, event (failure, retries, etc.) information per SG and for each clouds
6. Cost analysis for all cloud components.
7. Protection vulnerability analysis (for example, which VMs are not protected for example).
8. Trend analysis and projection based on previous usage history.

Having described the present invention, I claim:

1. A backup, archive and disaster recovery solution platform consists of:
Distributed storage systems across multiple clouds including private clouds (at primary and replicated sites) and public clouds;
A backup, archive, and disaster recovery application;
Existing IT infrastructures in the primary and replicated sites;
Groups of protected resources (i.e., Snapshot Groups) as defined by user. For example, a set of relevant virtual machines or file stores;
Per protection group policy for primary site, replicated site and public clouds.

2. A backup, archive and recovery solution as recited in claim 1, wherein data protection via concurrent snapshot for groups of virtual machines or file stores are performed, data are stored to the distributed storage systems across multiple clouds. The solution provides high data availability and is fault tolerant to storage system failures

3. A backup, archive and recovery solution as recited in claim 1, wherein scalability to data growth and increasing demand of backup and recovery operations are provided.

4. A backup, archive and recovery solution as recited in claim 1, wherein users can configure individual cloud resources including primary site and optional replicated-site and optional public cloud providers.

5. A backup, archive and recovery solution as recited in claim 1, wherein data reduction is performed by both BCADR application and DSS to reduce storage consumption cost.

6. A backup, archive and recovery solution as recited in claim 1, wherein the primary site or replicated are used as cache for recovery operations and public clouds are utilized to keep all necessary backup versions.

7. A backup, archive and recovery solution as recited in claim 1, wherein details of backup, recovery and garbage collections operations are specified.

8. A backup, archive and recovery solution as recited in claim 1, wherein a reference count mechanism is utilized to assist to garbage collect the staled data chunks in order to reduce the storage costs.

9. A backup, archive and recovery solution as recited in claim 1, where in the statistics are gathered and analyzed for all cloud components including the following information:
User backup and recovery activities;
History information of the protected resources;
Per protection group activities;
Storage consumption per protection group and detailed per-component analysis;
Data chunk access latency, bandwidth, system events (e.g., failure, retries, etc.) information per SG and for each clouds;
Cost analysis for all cloud components;
Protection vulnerability analysis (e.g., which VMs are not protected);
Trend analysis and projection based on previous usage history.
